(19) United States
(12) Patent Application Publication
(10) Pub. No.: US 2017/0242465 A1
(43) Pub. Date: Aug. 24, 2017

(54) COMPUTING DEVICES WITH CENTRALIZED POWER SOURCES

(71) Applicant: Microsoft Technology Licensing, LLC, Redmond, WA (US)

(72) Inventors: Bryan Kelly, Carnation, WA (US); Badriddine Khessib, Redmond, WA (US); Mark A. Shaw, Sammamish, WA (US); Shaun Harris, College Station, TX (US)

(21) Appl. No.: 15/048,580

(22) Filed: Feb. 19, 2016

(51) Int. Cl. G06F 1/26; G06F 1/30; H02J 7/00

(52) U.S. Cl. CPC G06F 1/263; H02J 7/0068; G06F 1/30; H02J 2007/0059

(57) ABSTRACT

Certain computer systems having centralized power sources are described herein. In one embodiment, a computer system can include a processing unit and an enclosure containing the processing unit. The processing unit includes a motherboard having a processor and a clock circuitry operatively coupled to the processor. The processing unit can also include a power supply that includes a first rail configured to supply power at a first voltage to the processor on the motherboard and a second rail configured to supply power at a second voltage to the clock circuitry on the motherboard. The motherboard does not include a coin-type battery electrically coupled to the clock circuitry.

### BACKGROUND

Datacenters typically include a large number of servers, network storage devices, and other types of computing or communications components housed in racks, cabinets, containers, or other types of enclosures. Each server can include one or more processors, memories, storage devices, or other types of electrical/mechanical components. During operation, the servers in datacenters can execute instructions, transmit messages, or perform other operations in order to provide desired cloud computing services to remote users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Inaccurate time keeping on servers or computers can negatively impact proper operations in datacenters. Inaccurate time on a server can cause authentication errors, login failures, or other operating issues. Inaccurate time can also cause a server to perform computations, programming updates, maintenance operations, or other operations at incorrect times. To ensure accurate timing, servers and computers typically include a clock circuitry (e.g., a real time clock) powered by a coin-type lithium ion battery. Thus, even when a main power source becomes unavailable or a server is turned off, the clock circuitry can continue to maintain accurate time.

However, coin-type lithium ion batteries can have high failure rates, for example, greater than three percent. Replacing failed coin-type lithium ion batteries can be labor intensive and costly. Typically, a maintenance person has to physically remove a server from a rack, disassemble the server, remove a failed battery, install a new battery, reassemble the server, reconnect the server to the rack, and power up the server. Each datacenter can have thousands if not millions of servers. Thus, replacing failed coin-type lithium ion batteries in large datacenters can incur significant operating costs and a loss of service to users.

Several embodiments of the disclosed technology are directed to replacing coin-type lithium ion batteries on individual servers with a centralized power source. In certain embodiments, a server can be provided with a power supply that supplies power to a processor of the server at a first voltage (e.g., about 12 volts). The power supply can also include a rechargeable battery and a voltage regulator configured to convert power from the rechargeable battery to a second voltage (e.g., about 3 volts) suitable for a clock circuitry on the server. Thus, when power is cycled on the processor of the server, the rechargeable battery can still supply power to the clock circuitry via the voltage regulator, and thus enabling the clock circuitry to continue maintaining accurate time.

Several embodiments of the disclosed technology can reduce maintenance costs and a loss of service in datacenters when compared to conventional techniques. For example, instead of utilizing a coin-type lithium ion battery with high failure rates, the rechargeable battery with much higher reliability and capacity than coin-type lithium ion batteries can provide power to a clock circuitry on individual servers. Such rechargeable batteries can typically have a life span much longer than that of the individual servers. As such, the rechargeable batteries may not require replacement for the life of the servers. Thus, maintenance costs and a loss of service associated with replacing failed coin-type lithium ion batteries on servers can be eliminated or at least reduced.

### BRIEF DESCRIPTION OF THE DRAWINGS

FIG. 1 is a schematic diagram illustrating a computing environment having processing units individually having a centralized power source in accordance with embodiments of the disclosed technology.

FIGS. 2A-2C are schematic diagrams each illustrating certain components suitable for the processing unit of FIG. 1 in accordance with embodiments of the disclosed technology.

FIG. 3 is a schematic diagram illustrating another computing environment having processing units individually having a centralized power source in accordance with embodiments of the disclosed technology.

FIG. 4 is a computing device suitable for certain components of the computing environment in FIGS. 1 and 3.

### DETAILED DESCRIPTION

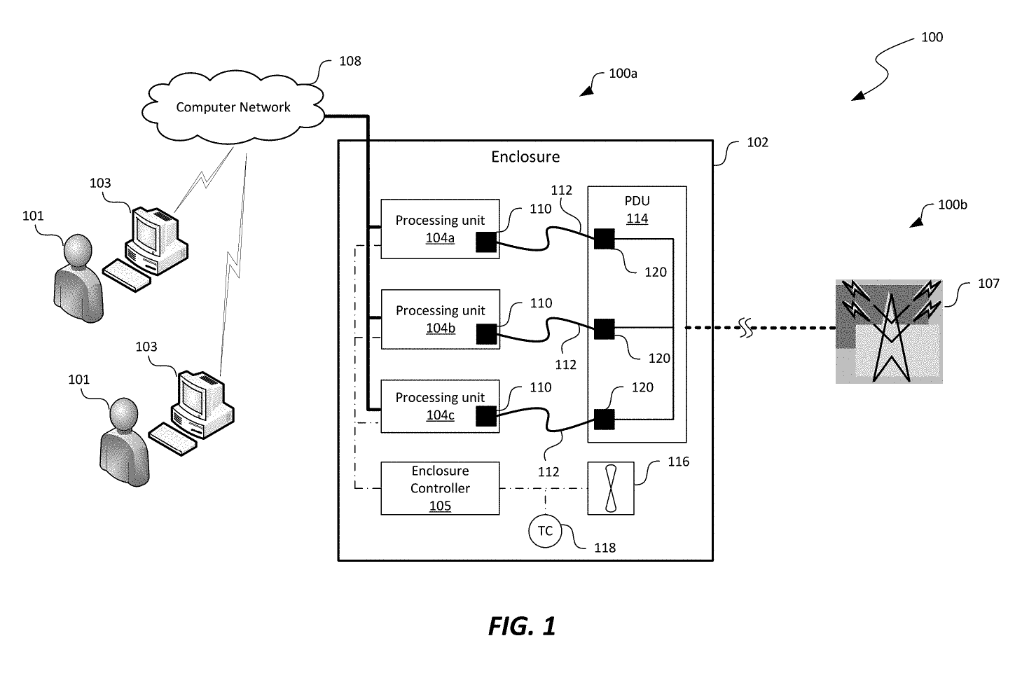

Certain embodiments of systems, devices, components, and modules for providing centralized power sources to servers or other suitable computing devices are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-4.

As used herein, the term “processing unit” generally refers to a computer assembly that has one or more computing devices housed in a case, frame, or other suitable structure. The computing devices can be individually configured to perform logic comparisons, arithmetic calculations, electronic communications transactions, electronic input/output, and other suitable types of computing functions. Example computing devices can include servers, computers, programmable logic controllers, network routers, network switches, network interface cards, data storage devices, or other suitable types of apparatus.

Also used herein, the term “power distribution unit” or “PDU” generally refers to an apparatus having a power inlet and multiple power outlets that are configured to distribute electrical power from a main power source (e.g., a power grid) to multiple processing units. The term “power inlet” generally refers to an electrical interface through which electrical power is received. A power inlet can include one or more appliance inlets, electrical switches, circuit breakers, voltage selectors, electromagnetic interference filters, surge protectors, ground fault interrupters, and/or other suitable electrical/mechanical components. A power outlet generally refers to an electrical interface through which electrical power is provided to, for example, a processing unit. A power outlet can include one or more of plugs, sockets, ground-fault interrupters, power wiring terminals, solenoids, electrical contacts, and/or other suitable electrical/mechanical components.

Inaccurate time keeping on computers or servers in datacenters can disrupt provision of cloud computing servers to users. Typically, servers in datacenters can each contain a clock circuitry that keeps accurate time. To ensure continued operation of the clock circuitry even when a server is powered down, the clock circuitry is normally powered by a coin-type lithium ion battery. However, the inventors have recognized that the coin-type lithium ion batteries can have significant failure rates. In a large datacenter with thousands and even millions of servers, replacing each failed coin-type lithium ion battery can be labor intensive and disruptive of normal operation of the datacenter. Several embodiments of the disclosed technology are directed to providing power to a clock circuitry on a server from a centralized power source instead of from a coin-type lithium ion battery, and thus reducing or even eliminating the costs associated with replacing coin-type lithium ion batteries.

FIG. 1 is a schematic diagram illustrating a computing environment 100 having processing units individually having a centralized power source in accordance with embodiments of the disclosed technology. As shown in FIG. 1, the computing environment 100 can include a computing system 100a and a utility infrastructure 100b that supports the computing system 100a. In one embodiment, the computing system 100a can be a datacenter. In other embodiments, the computing system 100a can include other suitable types of computing facilities. In the illustrated embodiment, the utility infrastructure 100b includes a main power source 107 (e.g., a power grid). In other embodiments, the utility infrastructure 100b can also include one or more HVAC systems, substations, diesel generators, and/or other components.

As shown in FIG. 1, the computing system 100a can include an enclosure 102 housing multiple processing units 104 (identified individually as first, second, and third processing units 104a-104c, respectively), a PDU 114, an enclosure controller 105, a temperature sensor 118 (e.g., a thermocouple), and an air mover 116 (e.g., a fan). The enclosure 102 can include a frame, scaffold, mount, or other structures in suitable shapes and sizes to house the foregoing components in racks or other suitable locations. Though only one enclosure 102 is shown in FIG. 1 as an illustration, in other embodiments, the computing system 100a can include any suitable number of enclosures 102 arranged in series, in parallel, or in other suitable manners.

The processing units 104 can be configured to implement one or more computations, network communications, input/output capabilities, and/or other suitable functionalities, for example, as requested by the users 101. In certain embodiments, the processing units 104 can individually include a web server, application server, database server, and/or other suitable computing component. In other embodiments, the processing units 104 can also include routers, network switches, analog/digital input/output modules, modems, and/or other suitable components. Even though three processing units 104a-104c are shown in FIG. 1 for illustration purposes, in other embodiments, the enclosure 102 can also contain one, two, four, or any other suitable number of processing units 104 of the same or different configuration.

A computer network 108 interconnects the processing units 104 to one another and to one or more client devices 103 (e.g., desktop computers) individually associated with corresponding users 101. The computer network 108 can include a wired medium (e.g., twisted pair, coaxial, untwisted pair, or optic fiber), a wireless medium (e.g., terrestrial microwave, cellular systems, WI-FI, wireless LANs, Bluetooth, infrared, near field communication, ultra-wide band, or free space optics), or a combination of wired and wireless media. The computer network 108 can also include routers, switches, modems, and/or other suitable computing and/or communications components operate according to Ethernet, token ring, asynchronous transfer mode, and/or other suitable protocols. In one embodiment, the computer network 108 can include, at least partially, the Internet. In other embodiments, the computer network 108 can include a wide area network, local area network, or other suitable types of computer network.

The PDU 114 can be configured to distribute electrical power from the main power source 107 to the individual processing units 104 in the enclosure 102. As shown in FIG. 1, the PDU 114 can include multiple power outlets 120 individually coupled to a power inlet 110 of one of the processing units 104 via a power cable 112. In certain embodiments, the PDU 114 can supply an alternating current, for example, at 220 volts, 110 volts, or other suitable voltage levels to the processing units 104. In other embodiments, the PDU 114 can also include rectifiers, filters, or other suitable electrical components (not shown) configured to supply a direct current, for example, at 12 volts to the individual processing units 104. In further embodiments, the PDU 114 can be relocated from the enclosure 102 to a location external to the enclosure 102.

In certain embodiments, the enclosure controller 105 can include a standalone computer, server, programmable logic controller, or other suitable types of computing device. In other embodiments, the enclosure controller 105 can be generally similar to one or more of the processing units 104. In further embodiments, the enclosure controller 105 can be implemented as a computing service provided by, for instance, one of the processing units 104 or a remote server (not shown).

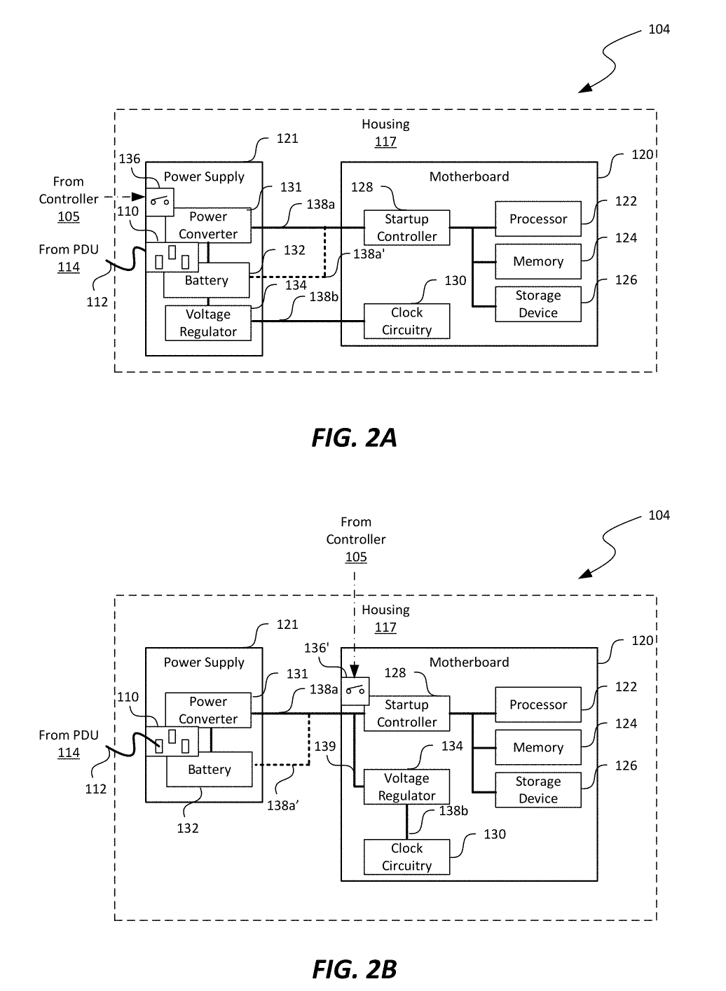

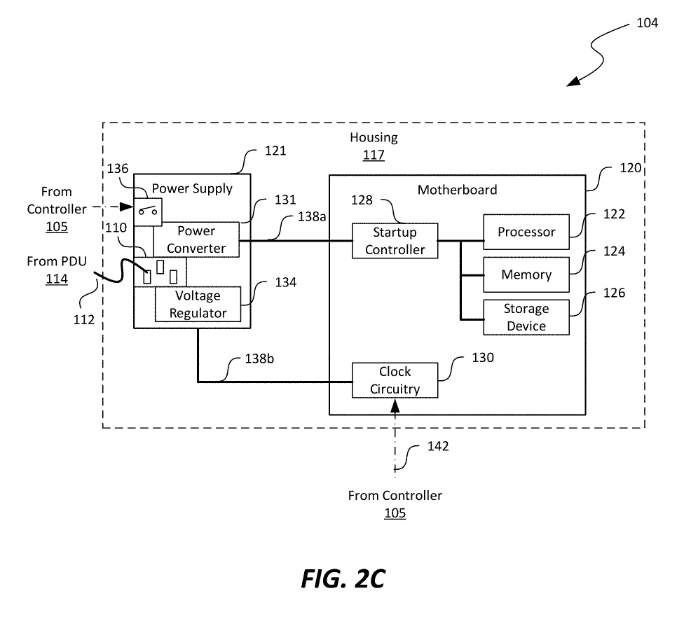

The enclosure controller 105 can be configured to control certain operations inside the enclosure 102. For example, in certain embodiments, the enclosure controller 105 can be configured to receive a temperature reading from the temperature sensor 118. If the temperature reading indicates an internal temperature in the enclosure 102 to be above a threshold (e.g., 30° C.), the enclosure controller 105 can instruct the air mover 116 to start introducing cooling air into and/or exhausting warm air from the enclosure 102. In other embodiments, the enclosure controller 105 can also be operatively coupled to the processing units 104 via, for example, RS232 or other suitable out-of-band connections that allow the enclosure controller 105 to turn on/off power, synchronize time keeping, or perform other operations to the processing units 104, as described in more detail below with reference to FIGS. 2A-2C.

As described in more detail below with reference to FIGS. 2A-2C, the individual processing units 104 can include a centralized power source that supplies power to both (i) one or more processors and other computing components as well as (ii) an onboard clock circuitry. The centralized power source is configured to continue supply power to the onboard clock circuitry even when power is removed from the processors and other computing components. As such, the processing units 104 can maintain accurate time even without utilizing coin-type lithium ion batteries.

FIGS. 2A-2C are schematic diagrams each illustrating certain components suitable for the processing units 104 of FIG. 1 in accordance with embodiments of the disclosed technology. In FIGS. 2A-2C and other figures herein, similar reference numbers correspond to similar components and/or functions. As shown in FIG. 2A, in certain embodiments, the processing unit 104 can include a housing 117 (shown in phantom lines for clarity) carrying a motherboard 120 and a power supply 121. In other embodiments, the processing unit 104 can also include daughterboards, optical indicators, network interface ports, or other suitable components (not shown).

In the illustrated embodiment, the motherboard 120 can include sockets, pins, or other suitable components (not shown) configured to receive and carry a processor 122 (e.g., a CPU), memory 124 (e.g., RAM), and storage device (e.g., a hard drive disk). Even though only one processor 122 is shown in FIG. 2A and other figures herein, in other embodiments, the motherboard 120 can also carry two, three, or any suitable number of processors, memories, storage devices, and/or other suitable types of components.

As shown in FIG. 2A, the motherboard 120 can also include a startup controller 128 and an onboard clock circuitry 130. The startup controller 128 can be configured to perform inrush current control and fault isolation. For example, when power is first applied to the motherboard 120, the startup controller 128 can detect the applied power and gradually ramp up current/voltage applied to the processor 122, memory 124, and/or storage device 126. As such, the risk of connector sparks, power supply issues, or system resets may be reduced. In certain embodiments, the startup controller 128 can also be configured to perform power monitoring by, for example, measuring current and voltage levels with integrated AC-to-DC converters or other suitable components. In one embodiment, the startup controller 128 can include a hot swap controller. In other embodiments, the startup controller 128 can also include other suitable sensors and/or electrical components.

The clock circuitry 130 can be configured to maintain time and provide a signal thereof to, for instance, the processor 122 and/or the memory 124. In one embodiment, the clock circuitry 130 can include a real time clock based on a crystal oscillator. In another embodiment, the clock circuitry 130 can also include a real time clock that utilizes a power line frequency. In further embodiments, the clock circuitry 130 can also include other suitable circuits for maintaining accurate time. As described in more detail below, unlike in conventional computer systems, the processing unit 104 does not include a coin-type lithium ion battery configured to supply power to the clock circuitry 130. Instead, the power supply 121 is configured as a centralized power source to supply power to both the computing components of the processing unit 104 and the clock circuitry 130.

As shown in FIG. 2A, the power supply 121 can include a power converter 131 coupled to the power inlet 110, a battery 132, and a voltage regulator 134. The power inlet 110 can include a socket or other suitable connectors configured to receive electrical power from the power outlet 120 (FIG. 1) of the PDU 114 via the cable 112. The power converter 131 can include one or more electrical transformers, buck/boost circuits, power filters, and/or other suitable components to convert received power at the power inlet 110 to a supply power at a first voltage (e.g., 12-volt DC) suitable for the battery 132 and/or other components on the motherboard 120.

In certain embodiments, the battery 132 can include a rechargeable lithium ion battery with a greater capacity and reliability than coin-type lithium ion batteries. For example, a suitable rechargeable lithium ion battery can have a capacity of 1000 mAh, 2000 mAh, 3000 mAh, 4000 mAh or other suitable capacity levels. In other embodiments, the battery 132 can also include lead-acid, nickel cadmium (NiCd), nickel metal hydride (NiMH), lithium ion polymer, or other suitable types of rechargeable battery. In the illustrated embodiment, the power converter 131 supplies power to charge the battery 132 and to power the startup controller 128 via a first rail 138a. In other embodiments, the battery 132 can supply power at the first voltage to the startup controller 128 in addition to or in lieu of the power converter 131 via an optional rail 138a′. In further embodiments, the optional rail 138a′ may be omitted.

The power supply 121 can also include a voltage regulator 134 coupled to the battery 132. The voltage regulator 134 can include one or more buck/boost circuits, dropdown resistors, capacitors, and/or other suitable electrical components configured to produce power at a second voltage (e.g., about 3 volts) from the power from the battery 132 at the first voltage. The voltage regulator 134 can then supply the power at the second voltage to the clock circuitry 130 on the motherboard 120. In the illustrated embodiment, the voltage regulator 134 is directly and electrically coupled to the battery 132. In other embodiments, the voltage regulator 134 can also be electrically coupled to the power converter 131 to receive power from the power converter 131. The voltage regulator 134 can also include a sensor (e.g., a resistor, not shown) to sense a loss of power from the power converter 131 and a switch (not shown) to switch from being connected to the power converter 131 to the battery 132.

In accordance with certain aspects of the disclosed technology, power at the second voltage supplied to the clock circuitry 130 can be maintained even if power to the power supply 121 is lost or if the power supply is turn off, for instance, during a power cycle of the processing unit 104. As shown in FIG. 2A, the power supply 121 can include a power supply switch 136 coupled to the power converter 131 and/or the battery 132. The power supply switch 136 can be configured to accept an input signal from, for instance, the enclosure controller 105 (FIG. 1) to turn on/off power at the first voltage supplied to the startup controller 128. However, the power supply switch 136 is configured to only control the first rail 138 (or and/or the optional rail 38a′) but not the second rail 138b supplying power to the clock circuitry 130 at the second voltage. As such, even when the power supply 121 is disconnected from the PDU 114 or otherwise powered down, the battery 132 can still provide uninterrupted power to the clock circuitry 130, and thus enabling the clock circuitry 130 to maintain accurate time without using any coin-type lithium ion batteries.

Even though the power supply 121 and the motherboard 120 are shown in FIG. 2A as containing certain components, in other embodiments, the power supply 121 and the motherboard 120 can contain different components to achieve similar or the same functionality. For example, as shown in FIG. 2B, instead of being part of the power supply 121, the voltage regulator 134 is carried by the motherboard 120. The voltage regulator 134 is configured to receive power at the first voltage from the power supply 121 via a branch line 139 of the first rail 138a. The voltage regulator 134 can then convert the received power at the first voltage to the second voltage and supply the converted power to the clock circuitry 130.

Also, as shown in FIG. 2B, the motherboard 120 can also include a startup power supply switch 136′ operatively coupled to the startup controller 128. The startup power supply switch 136′ is configured to turn on/off power from the startup controller 128 to the processor 122, memory 124, and/or storage device 126 based on an input signal from, for instance, the enclosure controller 105 (FIG. 10). However, operation of the startup power supply switch 136′ does not affect the voltage regulator 134. As such, even when the startup power supply switch 136′ is actuated to turn off power from the startup controller 128 to the processor 122, memory 124, and/or storage device 126, the voltage regulator 134 can still receive power from the battery 132 and/or the power converter 131. The clock circuitry 130 can thus maintain accurate time without using any coin-type lithium ion batteries.

In certain embodiments, as shown in FIG. 2C, the clock circuitry 130 can maintain accurate time even the battery 132 in the power supply 112 may be omitted. Instead, the power converter 131 can supply power to the startup controller 128 at the first voltage via the first rail 138a. The voltage regulator 134 can supply power to the clock circuitry 130 at the second voltage via the second rail 138b. As such, when power is turn off, for instance, based on an input signal from the enclosure controller 105 (FIG. 1), power on both the first and second rails 138a and 138b are turned off. As a result, the clock circuitry 130 would be reset to a default value (e.g., Jan. 1, 1979). However, as shown in FIG. 2C, the clock circuitry 130 can be configured to receive a synchronizing signal 142 from, for instance, the enclosure controller 105, via an RS232, RS485, or other suitable connection. Thus, when power on the first and second rails 138a and 138b are restored, time maintained on the clock circuitry 130 can be adjusted from the default value to a current time value based on the synchronization signal 142.

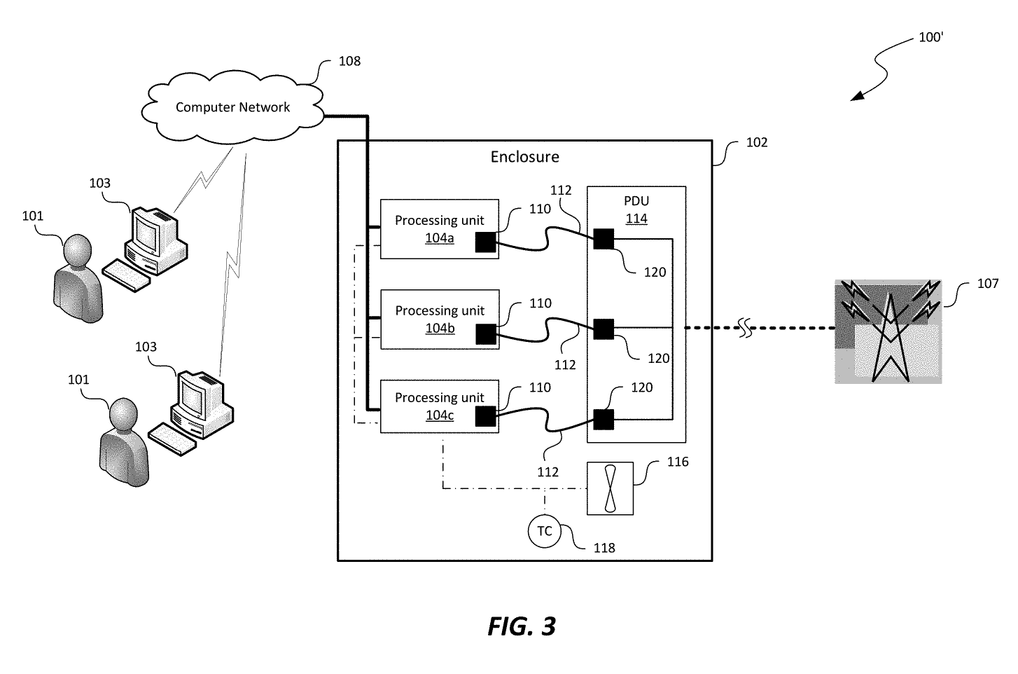

FIG. 3 is a schematic diagram illustrating another computing environment 100′ having processing units 104 individually having a centralized power source in accordance with embodiments of the disclosed technology. Unlike the computing environment 100 of FIG. 1, the enclosure 102 in FIG. 3 does not include a standalone enclosure controller 105. Instead, the third processing unit 104c can be configured to function as the enclosure controller 105 of FIG. 1. In certain embodiments, at least one of the processing units 104 can have a configuration different than others. For example, in one embodiment, the first and second processing units 104a and 104b can be configured as that shown in FIG. 2C while the third processing unit 104c can be configured as that shown in FIG. 2A or 2B. In other embodiments, all of the processing units 104 can have the same configuration.

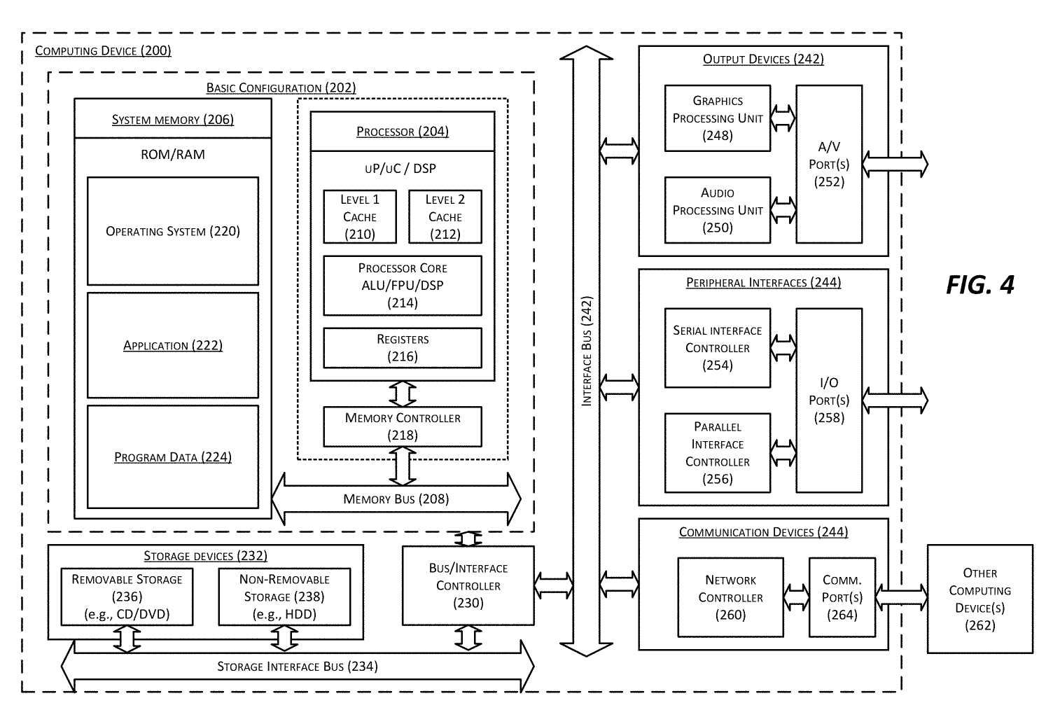

FIG. 4 is a computing device 200 suitable for certain components of the computing environment 100 in FIG. 1. For example, the computing device 200 can be suitable for the processing unit 104 or the enclosure controller 105 of FIG. 1. In a very basic configuration 202, the computing device 200 can include one or more processors 204 and a system memory 206. A memory bus 208 can be used for communicating between processor 204 and system memory 206.

Depending on the desired configuration, the processor 204 can be of any type including but not limited to a microprocessor (μP), a microcontroller (μC), a digital signal processor (DSP), or any combination thereof. The processor 204 can include one more levels of caching, such as a level-one cache 210 and a level-two cache 212, a processor core 214, and registers 216. An example processor core 214 can include an arithmetic logic unit (ALU), a floating point unit (FPU), a digital signal processing core (DSP Core), or any combination thereof. An example memory controller 218 can also be used with processor 204, or in some implementations memory controller 218 can be an internal part of processor 204.

Depending on the desired configuration, the system memory 206 can be of any type including but not limited to volatile memory (such as RAM), non-volatile memory (such as ROM, flash memory, etc.) or any combination thereof. The system memory 206 can include an operating system 220, one or more applications 222, and program data 224. This described basic configuration 202 is illustrated in FIG. 4 by those components within the inner dashed line.

The computing device 200 can have additional features or functionality, and additional interfaces to facilitate communications between basic configuration 202 and any other devices and interfaces. For example, a bus/interface controller 230 can be used to facilitate communications between the basic configuration 202 and one or more data storage devices 232 via a storage interface bus 234. The data storage devices 232 can be removable storage devices 236, non-removable storage devices 238, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 206, removable storage devices 236, and non-removable storage devices 238 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 200. Any such computer readable storage media can be a part of computing device 200. The term “computer readable storage medium” excludes propagated signals and communication media.

The computing device 200 can also include an interface bus 240 for facilitating communication from various interface devices (e.g., output devices 242, peripheral interfaces 244, and communication devices 246) to the basic configuration 202 via bus/interface controller 230. Example output devices 242 include a graphics processing unit 248 and an audio processing unit 250, which can be configured to communicate to various external devices such as a display or speakers via one or more A/V ports 252. Example peripheral interfaces 244 include a serial interface controller 254 or a parallel interface controller 256, which can be configured to communicate with external devices such as input devices (e.g., keyboard, mouse, pen, voice input device, touch input device, etc.) or other peripheral devices (e.g., printer, scanner, etc.) via one or more I/O ports 258. An example communication device 246 includes a network controller 260, which can be arranged to facilitate communications with one or more other computing devices 262 over a network communication link via one or more communication ports 264.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 200 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 200 can also be implemented as a personal computer including both laptop computer and non-laptop computer configurations.

Specific embodiments of the technology have been described above for purposes of illustration. However, various modifications can be made without deviating from the foregoing disclosure. In addition, many of the elements of one embodiment can be combined with other embodiments in addition to or in lieu of the elements of the other embodiments. Accordingly, the technology is not limited except as by the appended claims.

I/We claim:

1. A computer system, comprising:
a motherboard having a processor and a clock circuitry operatively coupled to the processor; and
a power supply electrically coupled to the motherboard, the power supply having:
a power converter configured to receive an input power and convert the input power to an output power at a first voltage;
a rechargeable battery electrically coupled to the power converter, the rechargeable battery being chargeable by the output power from the power converter;
a voltage regulator electrically coupled to the rechargeable battery, the voltage regulator being configured to receive power at the first voltage and convert the received power to a second voltage different than the first voltage;
a first rail configured to supply the output power to the processor at the first voltage; and
a second rail electrically coupled to the voltage regulator, the second rails being configured to supply power at the second voltage to the clock circuitry.

2. The computer system of claim 1 wherein the motherboard does not include a coin-type battery electrically coupled to the clock circuitry.

3. The computer system of claim 1 wherein the power supply further includes a switch operatively coupled to the power converter, wherein the switch is configured to turn off power supplied to the processor via the first rail while allowing the voltage regulator to continue supplying power to the clock circuitry via the second rail.

4. The computer system of claim 1 wherein the power supply further includes a switch operatively coupled to the power converter, wherein the switch is configured to turn off power supplied to the processor via the first rail while allowing the voltage regulator to continue supplying power to the clock circuitry via the second rail based on a remote input signal.

5. The computer system of claim 1 wherein voltage regulator is directly coupled to the battery electrically.

6. The computer system of claim 1 wherein voltage regulator is also electrically coupled to the power converter, and wherein the power supply further includes a switch configured to switch power to the voltage regulator from the power converter to from the battery upon detection of a power loss at the power converter.

7. The computer system of claim 1 wherein the clock circuitry is also configured to receive an external synchronization signal and to synchronize a time associated with the clock circuitry based on the received external synchronization signal.

8. A computer system, comprising:
a motherboard having a startup controller, a processor electrically coupled to the startup controller, and a clock circuitry operatively coupled to the processor; and
a power supply electrically coupled to the motherboard, the power supply having:
a power converter configured to receive an input power and convert the input power to an output power at a first voltage;
a rechargeable battery electrically coupled to the power converter, the rechargeable battery being chargeable by the output power from the power converter; and
an electrical rail configured to supply the output power to startup controller at the first voltage;
wherein the motherboard further includes a voltage regulator electrically coupled to the power supply via a branch of the electrical rail, the voltage regulator being configured to receive power at the first voltage and convert the received power to a second voltage different than the first voltage; and
wherein the voltage regulator is electrically coupled to the clock circuitry to supply power at the second voltage to the clock circuitry.

9. The computer system of claim 8 wherein the motherboard does not include a coin-type battery electrically coupled to the clock circuitry, and wherein the voltage regulator is configured to receive power from the battery via the electrical rail when the input power to the power converter is removed.

10. The computer system of claim 8 wherein the motherboard further includes a switch operatively coupled to the startup controller, wherein the switch is configured to turn off power from the startup controller to the processor without interrupting the voltage regulator to continue supplying power to the clock circuitry at the second voltage.

11. The computer system of claim 8 wherein the motherboard further includes a switch operatively coupled to the startup controller, wherein the switch is configured to turn off power from the startup controller to the processor without interrupting the voltage regulator to continue supplying power to the clock circuitry at the second voltage based on a remote input signal.

12. The computer system of claim 8 wherein the voltage regulator is electrically coupled to the battery via the electrical rail to receive uninterrupted power when the input power to the power converter is removed.

13. The computer system of claim 8 wherein the clock circuitry includes a real time clock.

14. The computer system of claim 8 wherein the clock circuitry is also configured to receive an external synchronization signal and to synchronize a time associated with the clock circuitry based on the received external synchronization signal.

15. A computer assembly, comprising:
a processing unit; and
an enclosure containing the processing unit, wherein the processing unit includes:
a motherboard having a processor and a clock circuitry operatively coupled to the processor; and
a power supply electrically coupled to the motherboard, the power supply includes:
a first rail configured to supply power at a first voltage to the processor on the motherboard; and
a second rail configured to supply power at a second voltage to the clock circuitry on the motherboard, the second voltage being different than the first voltage; and
wherein the motherboard does not include a coin-type battery electrically coupled to the clock circuitry.

16. The computer assembly of claim 15, further comprising an enclosure controller operatively coupled to the processing unit, wherein the power supply of the processing unit further includes a power supply switch configured to turn on/off power on the first rail based on a control signal from the enclosure controller without affecting power supplied to the clock circuitry on the second rail.

17. The computer assembly of claim 15 wherein the power supply further includes:
a power converter electrically coupled to the first rail, the power converter being configured to receive an input power and convert the input power to an output power at the first voltage; and
a voltage regulator electrically coupled to the second rail, the voltage regulator being configured to receive power at the first voltage and convert the received power to the second voltage.

18. The computer assembly of claim 15 wherein the power supply further includes:
a power converter electrically coupled to the first rail, the power converter being configured to receive an input power and convert the input power to an output power at the first voltage;
a voltage regulator electrically coupled to the second rail, the voltage regulator being configured to receive power at the first voltage and convert the received power to the second voltage; and
a rechargeable battery electrically coupled to the power converter, the rechargeable battery being chargeable by the output power from the power converter.

19. The computer assembly of claim 15 wherein the power supply further includes:
a power converter electrically coupled to the first rail, the power converter being configured to receive an input power and convert the input power to an output power at the first voltage;
a voltage regulator electrically coupled to the second rail, the voltage regulator being configured to receive power at the first voltage and convert the received power to the second voltage; and
a rechargeable battery electrically coupled to the power converter, the rechargeable battery being chargeable by the output power from the power converter, wherein the rechargeable battery is configured to supply power to the voltage regulator when the output power from the power converter is lost.

20. The computer assembly of claim 15, further comprising an enclosure controller operatively coupled to the processing unit, wherein:
the power supply of the processing unit does not include a battery source;
the enclosure controller is configured to supply a synchronization signal to the clock circuitry on the motherboard; and
the clock circuitry is configured to adjust a time thereon based on the synchronization signal from the enclosure controller during startup.
